(19) United States
(12) Patent Application Publication
(10) Pub. No.: US 2006/0065319 A1
(43) Pub. Date: Mar. 30, 2006

(54) QuickFlush valve kit for flushing of inboard/outboard marine engine cooling system

(76) Inventor: Mikulas Csitari, Media, PA (US)

Correspondence Address: MIKULAS CSITARI, 731 Bobbin Mill Road, Media, PA, 19063, US

(21) Appl. No.: 10/948,729

(22) Filed: Sep. 24, 2004

(51) Int. Cl. F17D 1/00

(52) U.S. Cl. 137/887

(57) ABSTRACT

Subject of this invention, the QuickFlush Valve Kit for Inboard/Outboard Marine Engines, available in two different versions (Unit 1 and Unit 2) is a simple, inexpensive device which allows for a thorough, regular, cost-effective, and convenient flushing of cooling system of inboard/outboard marine engines. At the same time, after it is easily installed on a boat—either by an owner or by boat manufacturer—it offers years of unmatched reliability, safety, and convenience of use thus contributing to extended life expectancy and more efficient operation of inboard/outboard marine engines.

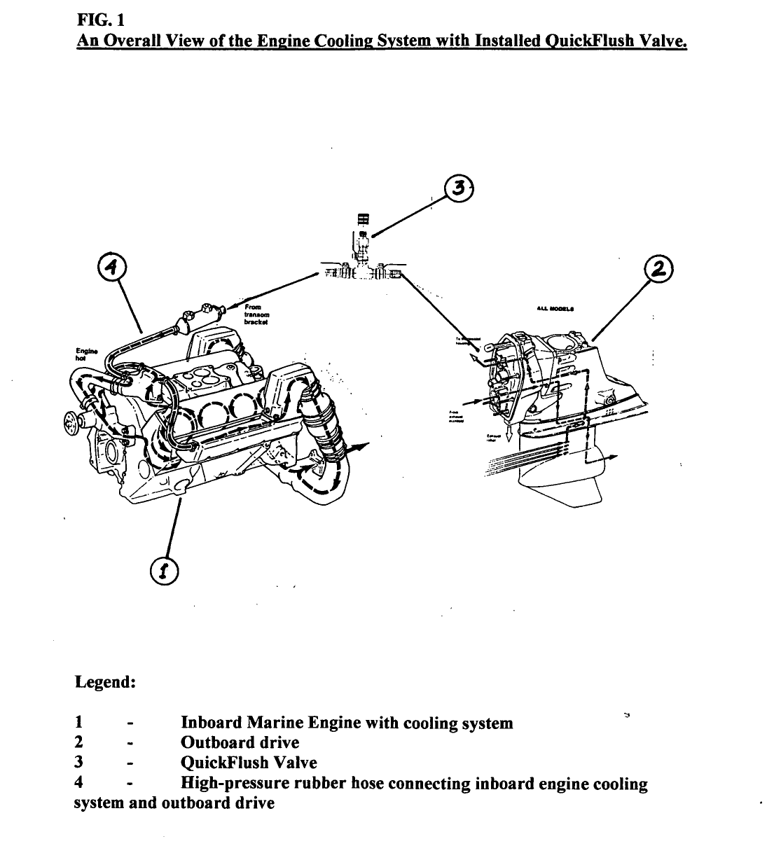

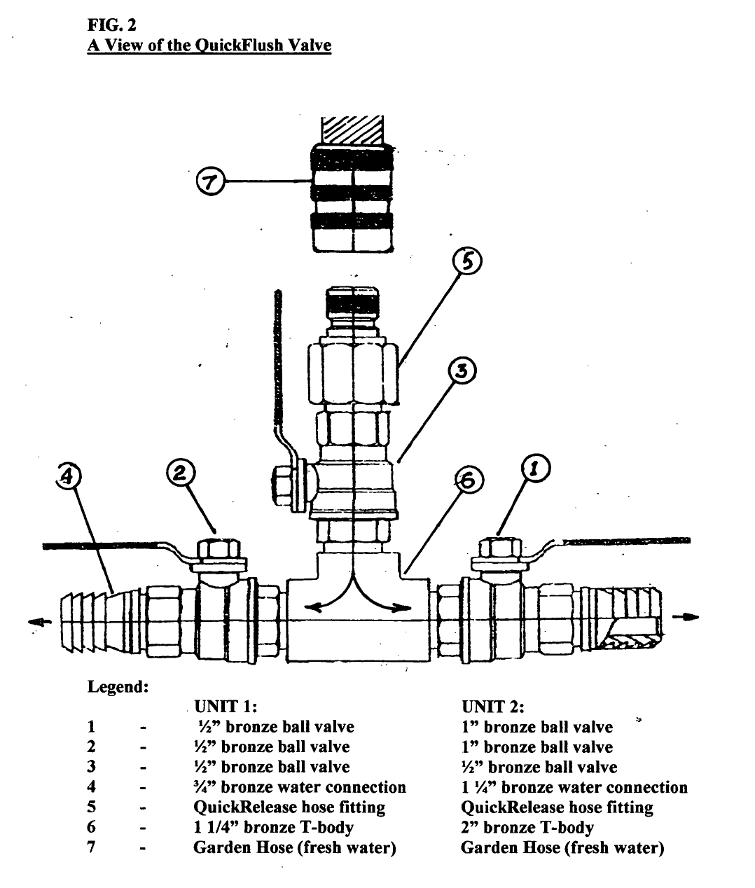

### CROSS-REFERENCE/U.S. PATENT DOCUMENTS

U.S. Pat. No. 3,931,828 January 1976 Lawler

U.S. Pat. No. 4,973,276 November 1990 Mavrelis

U.S. Pat. No. 5,362,265 November 1994 Gervais

### BACKGROUND OF THE INVENTION

1) Field of Invention

This invention relates generally to flushing of salt-water and marine sediments with fresh water in inboard/outboard marine engines.

2) Prior Art Problems

Cooling systems of inboard/outboard marine engines installed and operating on boats need proper and regular flushing to considerably prolong life expectancy and to improve performance of these engines.

Existing inboard/outboard marine engines do not have flushing units allowing for easy, thus economical and effective, performing of flushing in necessary intervals. Boat manufacturers do not install any flushing units because they do not see any suitable units available on the market.

Currently, very inconvenient and costly solutions to the need to flush the engine's cooling system require removing the boat from water and performing the flushing on dry land.

One method (“barrel method”) uses a barrel filled with fresh water. Outdrive part of the engine is than immersed into the barrel with water and it is sucked into cooling system in the same way as a sea water would be when the boat is in water and sea water is being used for cooling the engine. Fresh water from the barrel flushes the cooling system and returns to the barrel via discharge hole next to a propeller. Then it is sucked back to be used repeatedly for flushing and discharge back to the barrel. As the flushing water in the barrel gets dirty from the sediments it need to be replaced frequently.

Another method, still requiring getting the boat on dry land uses “ear muffs” apparatus. This flushing method is effective and can be used for winterizing, but the major cost and inconvenience obstacle of getting the boat on dry land remains thus, in practical terms, limiting use of this method and being able to benefit from a regular and thorough flushing of the cooling system.

### SUMMARY OF INVENTION

It is the principle of this invention to provide an instrument(s) which allows for an effective performance of flushing tasks on the mentioned inboard/outboard marine engines without the described difficulties, inconveniences, as it does not require getting boat on dry land and unlike “barrel method” it also provides for a continuous supply of fresh water thus assuring a thorough flushing action.

Flushing is thus performed, with much higher convenience, ease and cost-effectively while the boat remains in the water.

The stated objectives are achieved by utilization of invented device. The device (flushing valve kit) is able to separate flow of flushing medium (water) so it does not flow—in the marine engine application—into an inboard engine and outboard drive at the same time. This separation and the option to direct the flow of flushing medium either into the inboard engine or into the outboard drive is a fundamental precondition for flushing of the engine and the drive.

The invention allows flushing of the engine cooling system either with using just a pressurized fresh water from the garden hose or, for even better effect and efficiency, the engine cooling system can be flushed even more thoroughly while the engine is running and raw water pump on the engine provides for substantial additional (fresh) water flushing flow through the engine cooling system.

Outboard drive is flushed only with pressurized fresh water coming from the garden hose as the raw water pump and the engine must not be running while flushing outboard drive.

QuickFlush is a T-shaped unit consisting o 3 valves. It is made of marine bronze or stainless steel. Valves no. 1 and 2 are at the ends inserted into the engine's cooling system intake hose. Valve no. 3 is equipped with QuickRelease connection for fresh water garden hose.

Note: While the primary purpose of this invention, i.e. QuickFlush Valve, is to serve proper, convenient, and cost-effective flushing of the marine engine's cooling system it can be equally well utilize for engine winterization where antifreeze liquid is used in place of a fresh water, also delivered via a garden hose.

### DESCRIPTION OF OPERATION

a) Flushing Inboard Engine's Cooling System:
1) Valve no. 1 (leading to the outboard drive) is to be closed.
2) Valve no. 2 (going to inboard engine's cooling system) is to be opened.
3) A garden hose with fresh water is to be connected to valve no. 3 using QuickRelease connection
4) Cooling system can be flushed either with engine running or with engine shut down (off position), using only water pressure from the garden hose.

Fresh water flows from the garden hose attached to valve no. 3 and it goes though valve no. 2 into the inboard engine's cooling system. It cleans the system and removes the salt-water sediments and debris and water is discharged at discharge hole next to the propeller.

At the end of flushing operation, the operation is as follows:
1) Engine is shut off the engine and the raw water pump stop
2) Valve no. 2 is closed

b) Flushing of Outboard Drive's System
1) After flushing of the inboard engine cooling system is completed, flushing of outboard drive is performed.
2) Inboard engine is always shut down and flushing is always performed only by using water pressure from a garden hose.
3) Valve no. 2 (leading to inboard engine's cooling system) is closed.
4) Valve no. 1, leading to outboard drive is opened.
5) Valve no. 3, bringing in fresh water via garden hose is opened.

Fresh water from the garden hose runs though valves no. 3 and no. 1 into the outboard drive's system removing debris and flushing it.

At the end of outboard drive's system flushing operation valve no. 3 is closed and garden hose is disconnected from it. Valves no. 1 and valve no. 2 are to be opened allowing for uninterrupted inflow of raw (sea) water when the boat and thus the engine are again in operation.

I claim:

1) An inboard/outboard engine flushing device manufactured from a material selected from a group consisting of either a bronze, stainless steel or other suitable non-ferrous material, comprising of the following elements: about 2″ (Unit 1) to about 2.5″ (Unit 2) long T-shaped body of an outside diameter (OD) between about 1¼″ (Unit 1) and about 2″ (Unit 2) with about 1/16″ to ⅛″ wall thickness connected at two opposite ends of T-shape to ½″ bronze ball valves fitted with water-hose fitting and at the “leg” of the T-shape connected to a ½″ bronze ball valve to which a garden hose is connected via QuickRelease coupling.
